(19) United States
(12) Patent Application Publication
(10) Pub. No.: US 2009/0236455 A1
(43) Pub. Date: Sep. 24, 2009

(54) ROLLER PRESS, IN PARTICULAR FOR INTERPARTICLE CRUSHING

(75) Inventors: Siegfried Strasser, Much (DE); Andreas Enders, Oelde (DE); Silke Liedtke, Krefeld (DE)

Correspondence Address: GREER, BURNS & CRAIN, 300 S WACKER DR, 25TH FLOOR, CHICAGO, IL, 60606, US

(73) Assignee: KHD HUMBOLDT WEDAG GMBH, Köln (DE)

(21) Appl. No.: 12/302,672

(22) PCT Filed: Jun. 1, 2007
(86) PCT No.: PCT/EP2007/004855

§ 371 Date: Nov. 26, 2008

(30) Foreign Application Priority Data
Jun. 2, 2006 (DE) 10 2006 025 833.9

(51) Int. Cl. B02C 4/28; B30B 15/30; B02C 4/02

(52) U.S. Cl. 241/224; 241/222; 241/227

(57) ABSTRACT

A roller press which is used, in particular, for material bed comminution and into the material feed hopper of which both coarse-grained material, such as, for example, fresh material, and fine-grained material, such as, for example, recirculated grits from a downstream sifter and/or, for example, fly ash, are introduced, wherein the stability of the material bed or grinding bed and therefore a high grinding efficiency are ensured despite the considerably different grain size and grain distribution in the two material flows to be drawn into the roller nip. A pressure screw which conveys the fine material under pressure is inserted into the material feed hopper through at least one fine-grain inlet opening in the hopper, a nozzle-like outlet, in particular a flat nozzle, of the pressure screw extending into a central region of a material draw-in of the press roller nip.

### BACKGROUND OF THE INVENTION

The invention relates to a roller press having two rotatably mounted rollers which are driven in opposite directions, are separated from one another by a press roller nip and are intended for pressure treatment, in particular for material bed comminution or compaction or briquetting of granular material, having a material feed hopper which is arranged above the roller nip having an inlet opening for introducing coarse material and an inlet opening for introducing fine material such as, for example, the recirculated grits from a sifter device connected in the circuit.

During the operation of roller presses of this type for the pressure treatment of granular material, the individual pieces or particles of the grinding material such as, for example, raw cement material, cement clinker, ores or the like which have been introduced into the material feed hopper have to be picked up by the oppositely driven rollers and drawn into the roller nip by friction. When a high pressure is applied, the individual particles of the grinding material drawn into the region of the narrowest roller nip are comminuted against one another in a material bed, that is to say in a material heap compressed between the two roller surfaces, and this is known as material bed comminution.

If at least some of the feed material for the roller press already has a very fine grain size since, for example, large quantities of the grits from a sifter arranged downstream of the roller press, if appropriate via a fine mill, are recirculated into the material feed hopper to the fresh feed material, this can inpair the material draw-in capacity of the rollers and reduce the throughput performance of the roller press. This is because the supply of material flows with considerably different grain size and grain distribution is problematic owing to segregation in the material feed hopper to the roller press. Specifically, the bulk density of the recirculated grits is significantly smaller than the bulk density of the fresh feed material, that is to say the porosity of the sifter grits is greater than that of the fresh feed material. The alternating supply of coarse and fine material to the roller nip disrupts the stability of the grinding bed and reduces the grinding efficiency.

In DE 39 16 641 A1, FIGS. 2 and 3, it has therefore already been proposed, in the case of a roller press for material bed comminution, to introduce the coarse material, for example fresh grinding material, and the fine material, for example recirculated sifter grits, slag sand etc., separately from one another into the material feed hopper and to precompact the fine material in the material feed hopper by means of a dedicated precompaction roller in order to thereby approximate the porosity of the fine material to the porosity of the coarse material or fresh material and to improve the material draw-in condition of the material consisting of fresh material and precompacted fine material in the roller nip of the actual high-pressure roller press. However, this technology requires the use of at least three rollers and is accordingly complex.

In the case of the material bed comminution roller press in DE-38 23 929 A1, three rollers are likewise used in a machine frame, specifically a driven main roller, a non-driven idle roller which is pressed onto the upper region of said main roller by means of hydraulic pressing devices, and a second non-driven idle roller which is pressed onto the lower region of said main roller by means of hydraulic pressing devices. In this solution, exclusively the fresh feed material is pre-comminuted in the first (upper) roller nip, whereas the recirculated sifter grits from a downstream sifter are introduced into the second (lower) roller nip of the roller press which operates, overall, in two stages, i.e. the compacted material which has already been pre-pressed in the upper roller nip and the porous material of the sifter grits which, by contrast, is comparatively very loose must be drawn into the lower roller nip by friction, and this is problematic for the above-mentioned reasons.

In addition, for the press-compaction of fine-grained salts, DE-C 38 02 173 discloses a roller press above the roller nip of which a plurality of charging hoppers each containing a screw feeder are arranged next to one another, i.e. all of the feed material is supplied to the roller nip via the screw feeders. Separate treatment and feeding of coarse material and fine material into the roller nip does not take place in this case.

### SUMMARY OF THE INVENTION

The invention is based on the object of providing a roller press which is used, in particular, for material bed comminution, has a comparatively simple construction and into the material feed hopper of which both coarse-grained material, such as, for example, fresh material, and fine-grained material, such as, for example, recirculated grits from a downstream sifter and/or, for example, fly ash, are introduced, wherein the stability of the material bed or grinding bed and therefore a higher grinding efficiency are ensured despite the considerably different grain size and grain distribution in the two material flows to be drawn into the roller nip.

In the roller press according to the invention, in particular for material bed comminution, the two material flows of coarse-grained material and fine-grained material are introduced into the material feed hopper separately from one another. For this purpose, the top side of the material feed hopper is provided with a coarse-material inlet opening and preferably the side lying transversely with respect to the roller nip is provided with at least one fine-material inlet opening. According to the invention, a pressure screw which conveys the fine grain under pressure is inserted into the material feed hopper through the at least one fine-material inlet opening in the latter, the nozzle-like issue of said pressure screw reaching into the central region of the material draw-in of the press roller nip of the roller press. In this case, the fine-grain material is surrounded by the coarse-grain material in the high-pressure zone of the roller nip, and this minimizes the risk of segregation of the two material flows in the material feed hopper and an alternating supply of coarse and fine material into the roller nip. This is particularly effective if the nozzle of the pressure screw for introducing the fine material is a flat nozzle which is arranged above, and lies parallel to, the narrowest roller nip.

According to a further feature of the invention, the nozzle of the pressure screw, which is inserted into the material feed hopper from the side transversely with respect to the roller nip, in a manner lying horizontally or obliquely with respect to the horizontal, can be linked to the issue of the pressure screw by means of a joint. This means that the nozzle, in particular a flat nozzle, can be centered in the center of pressure itself within the pressure zone in the material bed above the roller nip of the roller press.

### BRIEF DESCRIPTION OF THE DRAWINGS

The invention and further features and advantages thereof are explained in more detail with reference to the exemplary embodiments illustrated in the drawing, in which:

FIG. 1: shows a first embodiment of the roller press according to the invention, having a fine-material pressure screw which is arranged approximately horizontally and is inserted into the material feed hopper, and

FIG. 2: shows a second embodiment of the roller press, in which the pressure screw is arranged at an angle obliquely with respect to the horizontal.

### DETAILED DESCRIPTION OF THE DRAWINGS

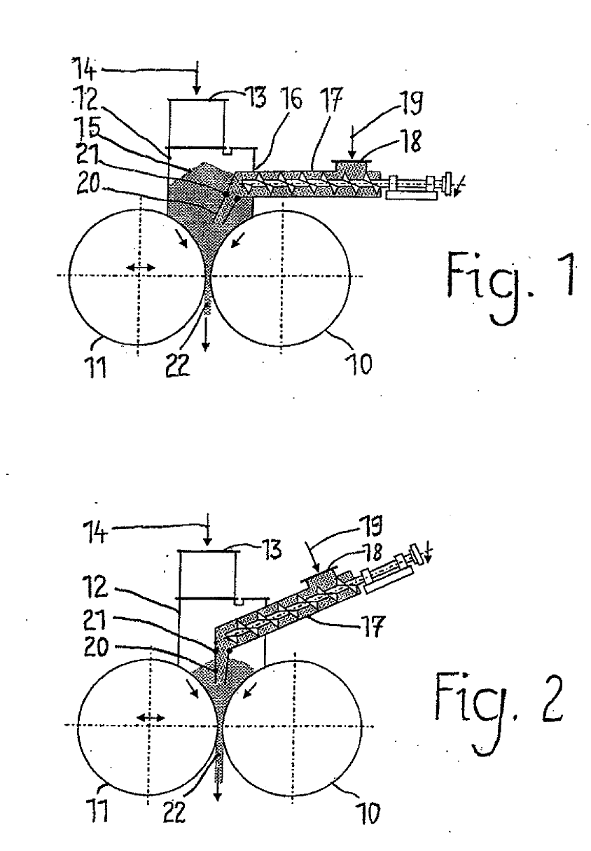

According to FIG. 1, the roller press according to the invention has two rotatably mounted rollers 10, 11 which can be rotated in opposite directions and are separated from one another by a press roller nip, of which rollers the roller 10 is the fixed roller, whereas the other roller 11 is designed as a loose roller which can be moved transversely with respect to the roller nip and of which the bearing housings are supported by means of hydraulic cylinders, which are used to apply the roller pressing force.

A material feed hopper 12 which is provided on the top side with an inlet opening 13 for introducing coarse material 14, which is supplied under the action of gravity, is arranged above the roller nip. The coarse material 14 may be, for example, fresh material to be comminuted or ground such as, for example, cement clinker etc., and the top side of the slope of this bulk material within the material feed hopper 12 is annotated by 15. In addition, the side of the material feed hopper 12 is provided with at least one fine-material inlet opening 16 through which a pressure screw 17 which conveys the fine material under pressure is inserted into the feed hopper 12, the nozzle-like issue of said pressure screw reaching into the central region of the material draw-in of the press roller nip. The grain size and grain distribution of the fine material 19 introduced into the feed opening 18 of the pressure screw 17 are considerably different from those of the coarse material 14. The grain size of the fine material 19 introduced can therefore be up to 100% <3 mm, for example; this is the case when introducing, for example, fine, recirculated sifter grits, fly ash, slag sand, finely ground slag etc.

The nozzle at the issue of the pressure screw 17 for introducing the fine fraction 19 is a flat nozzle 20 which is arranged above, and lies parallel to, the narrowest roller nip and is arranged within the material bed heap 15. This flat nozzle 20 can be linked to the issue or outlet of the pressure screw 17 by means of a joint 21. In any case, the nozzle 20 of the pressure screw 17 is surrounded on all sides by the coarse fraction 15 otherwise located in the roller nip in the center of pressure of the region of material draw-in of the press roller nip, and this avoids segregation of the two material flows in the region of the narrowest roller nip, in which the comparatively high roller pressure becomes effective in the material heap during the material bed comminution.

In contrast to FIG. 1, in the exemplary embodiment of FIG. 2 the pressure screw 17 lying transversely with respect to the roller nip is inserted into the material feed hopper 12 of the rolling press in a manner lying obliquely with respect to the horizontal, i.e. the material feed end of the pressure screw 17 is at a higher point than the flat nozzle 20 of the issue of the pressure screw. This solution also affords the additional advantage that the assembly and dismantling of the roller 10 are not hindered by the pressure screw 17.

In all the exemplary embodiments, the pressing force exerted on the material by the rollers 10, 11 of the roller press is more than 2 MN/m of roller length. The grain size of a substantial portion of the fed coarse material 14 may be greater than the width of the narrowest roller nip of, for example, 20 mm; this is the case, for example, with cement clinker which is to be ground, has not been pre-comminuted and has a grain size of, for example, up to 100 mm, and therefore the feed material in the narrowest roller nip is then comminuted by means of a combined individual grain comminution and material bed comminution. The material emerges from the roller nip in comminuted and partially agglomerated form, i.e. press-compacted to form scabs 22 which can already contain a relatively high content of particles reduced to the desired end fineness (e.g. 30% <90 μm). The scabs 22 are then deagglomerated and sifted in a downstream device, with the sifter grits 19 being recirculated to the pressure screw 17 and from there into the narrowest roller nip of the rolling press.

As is apparent from the foregoing specification, the invention is susceptible of being embodied with various alterations and modifications which may differ particularly from those that have been described in the preceding specification and description. It should be understood that we wish to embody within the scope of the patent warranted hereon all such modifications as reasonably and properly come within the scope of our contribution to the art.

1-6. (canceled)

7. A roller press having two rotatably mounted rollers which are driven in opposite directions, are separated from one another by a press roller nip for pressure treatment, having a material feed hopper which is arranged above the roller nip and has an inlet opening for introducing coarse material and at least one inlet opening for introducing fine material, comprising:
a pressure screw which conveys the fine material under pressure being inserted into the material feed hopper through the at least one fine-material inlet opening in the material feed hopper, a nozzle-like outlet of the pressure screw reaching into a central region of a material draw-in of the press roller nip.

8. The roller press according to claim 7, wherein the nozzle-like outlet of the pressure screw for introducing the fine fraction is a flat nozzle which is arranged above, and lies parallel to, a narrowest portion of the roller nip.

9. The roller press according to claim 7, wherein the pressure screw is inserted into the material feed hopper from a side transversely with respect to the roller nip, in a manner lying one of horizontally or obliquely with respect to the horizontal.

10. The roller press according to claim 7, wherein the nozzle-like outlet of the pressure screw is linked to an outlet of the pressure screw by means of a joint.

11. The roller press according to claim 7, wherein the nozzle-like outlet of the pressure screw is surrounded on all sides by the coarse fraction located in the roller nip in the center of pressure of the region of material draw-in of the press roller nip.

12. The roller press according to claim 7, wherein the grain size of the fine material to be conveyed by the pressure screw is up to 100% <3 mm.

13. A roller press comprising:
two rotatably mounted rollers which are arranged to be driven in opposite directions,
the two rotatably mounted rollers being separated from one another by a press roller nip,
a material feed hopper arranged above the roller nip having an inlet opening for introducing coarse granular material and at least one inlet opening for introducing fine granular material,
a pressure screw arranged to convey the fine granular material under pressure being inserted into the material feed hopper through the at least one fine granular material inlet opening,
the pressure screw having a nozzle-like outlet reaching into a central region of a material draw-in of the press roller nip.

14. The roller press according to claim 13, wherein the nozzle like outlet of the pressure screw is a flat nozzle which is arranged above, and lies parallel to, a narrowest portion of the roller nip.

15. The roller press according to claim 13, wherein the pressure screw is inserted into the material feed hopper from a side transversely with respect to the roller nip, in a manner lying horizontally with respect to the horizontal.

16. The roller press according to claim 13, wherein the pressure screw is inserted into the material feed hopper from a side transversely with respect to the roller nip, in a manner lying obliquely with respect to the horizontal.

17. The roller press according to claim 14, wherein the nozzle-like outlet of the pressure screw is linked to an outlet of the pressure screw by a joint.

18. The roller press according to claim 13, wherein the nozzle-like outlet of the pressure screw is surrounded on all sides by the coarse fraction located in the roller nip in the center of pressure of the region of material draw-in of the press roller nip.

19. The roller press according to claim 13, wherein the grain size of the fine granular material to be conveyed by the pressure screw is up to 100% <3 mm.
